(19) United States
(12) Patent Application Publication
(10) Pub. No.: US 2006/0107903 A1
(43) Pub. Date: May 25, 2006

(54) Expandable structure

(76) Inventor: Ju-Young Jin, Xiamen (CN)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/200,792

(22) Filed: Aug. 9, 2005

Related U.S. Application Data
(60) Provisional application No. 60/600,275, filed on Aug. 9, 2004.

(51) Int. Cl. A01K 1/03

(52) U.S. Cl. 119/499

(57) ABSTRACT

An enclosure may be used to house one or more animals, such as cats, dogs or other household pets. The enclosure is preferably configured to be moved between an expanded or use position and a collapsed or storage position. Advantageously, the collapsed position may allow the enclosure to be easily shipped and transported. In addition, the enclosure may include one or more living hinges that facilitates moving the enclosure between the use and collapsed positions. Further, when the enclosure is in the collapsed position, the roof is preferably disposed between the walls and the floor so that the enclosure can be disposed within a relatively small and compact package.

### CROSS-REFERENCE TO RELATED APPLICATIONS This application claims priority to and the benefit of U.S. provisional patent application Ser. No. 60/600,275, filed Aug. 9, 2004 and entitled PET HOUSE, which is incorporated by reference in its entirety.

### BACKGROUND OF THE INVENTION

1. Field of the Invention

This invention generally relates to enclosures and, in particular, to enclosures configured to move between a collapsed configuration and an expanded configuration.

2. Description of Related Art

Conventional pet houses or animal shelters are often constructed from materials such as wood. For example, conventional pet houses may have walls, roof and floor constructed from wood. In particular, conventional pet houses may be constructed from plywood or particle board, and conventional pet houses may be assembled with nails, screws and/or bolts. These conventional pet houses constructed from wood are often relatively heavy and time consuming to assemble.

Known pet houses, such as dog houses, may have a variety of shapes and sizes. For example, conventional dog houses may be designed to resemble a conventional house. That is, a conventional dog house may include four walls with a generally rectangular or square configuration. A conventional dog house may also include a slope or slanted roof and a door, if desired.

Many conventional pet houses are intended to remain in a fixed or stationary position. For example, conventional pet houses may be securely attached to the ground or connected to other structures such as a concrete pad, driveway, fence or nearby building. Advantageously, if the pet house is securely attached to the ground or other structure, then the pet house will not be unintentionally moved or displaced.

It is also known to construct pet houses or animal shelters that are readily movable. This may allow the pet house to be easily moved from one location to another. Thus, this type of pet house may be used while traveling, vacationing and on trips. These known structures, however, are often relatively heavy and awkward to move because of the large size and weight of the structures. In addition, while these known structures may be collapsible or foldable, the structures may still be bulky and difficult to move. Further, these known structures may be difficult to move between the collapsed and unfolded positions. For instance, known structures may require two or more people to move the pet house between the folded and unfolded positions.

Conventional foldable or collapsible pet houses may still require a large amount of space in the folded or collapsed position. Thus, these conventional pet houses may be costly to ship and may require a large amount of storage space both at the manufacture's facility and the retail store. In addition, these conventional pet houses may be difficult for the consumer to take home from the store because of the large size and weight of the structure. Further, conventional foldable pet houses may be difficult to store because of the size and weight of the structure.

Known pet houses may also require a substantial amount of maintenance. For example, pet houses constructed from wood may need to be periodically painted and/or stained. In addition, the wood may rot or otherwise deteriorate over time. Known pet houses may also include parts or components that may be easily damaged or broken, and these components may be difficult and costly to repair and/or replace.

Known pet houses may also be constructed from other materials such as metal or plastic. Disadvantageously, metal pet houses may become unbearably hot during the summer months and intolerably cold during the winter. Similarly, known pet houses constructed from plastic may also be unusable during extremely hot or cold temperatures.

Conventional pet houses may also include an opening or entrance to allow an animal, such as a cat or dog, to enter and exit the structure. The pet house may also include a door or gate, if desired.

Disadvantageously, conventional pet houses that are movable between use and collapsed positions often include a number of additional components and structures to allow the pet house to be moved between the use and collapsed positions. For example, conventional pet houses may include one or more braces, rods, pulleys, cables, and the like to allow the structure to be moved between the use and collapsed positions. Undesirably, these additional components may increase the cost and make the structure more difficult to assemble.

In addition, many conventional pet houses are constructed from numerous parts and components. These numerous parts and components may make the pet house difficult and time consuming to assemble and disassemble.

### BRIEF SUMMARY OF THE INVENTION

A need therefore exists for a structure that eliminates or diminishes the disadvantages and problems described above.

One aspect is an animal enclosure that may be movable between an expanded or use position and a collapsed or storage position. Desirably, the animal enclosure is easily foldable between the expanded or use position and the collapsed or storage position. Preferably, when the animal enclosure is in the collapsed position, the animal enclosure requires a relatively small amount of space. Advantageously, this may allow the animal enclosure to be more easily moved, shipped and transported.

Another aspect is an animal enclosure that may be constructed from a relatively lightweight material such as plastic. Advantageously, the lightweight animal enclosure may be relatively easy to move, ship and transport.

Yet another aspect is an animal enclosure that may be constructed from a material that has relatively good insulating properties. This may allow the animal enclosure to be used in a wide range of environments and locations.

Still another aspect is an animal enclosure that may be quickly and easily movable between a use position and a collapsed position. Preferably, the animal enclosure can be quickly and efficiently moved between such positions. This may allow the animal is, enclosure to be quickly and easily used in a desired location and then transported to another location or stored for use at a later date. Desirably, the animal enclosure is relatively straightforward to expand and also to collapse.

A further aspect is an animal enclosure that may be constructed from relatively lightweight materials such as blow-molded plastic. Advantageously, blow-molded plastic parts may be used to form, for example, the walls, roof, and/or floor of the animal enclosure. The blow-molded plastic parts may also be used to form other parts of the animal enclosure such as gables or corners. The animal enclosure may also be constructed from components constructed from other materials such as injection molded plastic, rotary molded plastic, compression molded plastic, metal and the like The blow-molded plastic components are desirably designed to create rigid, high-strength structures that are capable of withstanding repeated use and wear. Significantly, the blow-molded plastic components may be easily manufactured and formed into the desired size and shape. In addition, the blow-molded components can form structural elements of the animal enclosure to minimize the number of parts required to construct the animal enclosure. One skilled in the art will appreciate that frames, braces and other types of supports and members may also be used to construct the animal enclosure, if desired.

A still further aspect is the animal enclosure may include blow-molded components with one or more features formed in the blow-molded components. Advantageously, these features may be integrally formed in the various components during the blow-molding process as part of a unitary, one-piece structure. Significantly, these features may improve the appearance and/or functionality of the animal enclosure.

Advantageously, the animal enclosure may be relatively simple to manufacture because it preferably consists of various components constructed from blow-molded plastic. The blow-molded plastic components may include two opposing walls that are spaced apart by a relatively small distance, which increase the strength and rigidity of the components. The blow-molded plastic components may also include one or more depressions or tack-offs that are sized and configured to increase the strength of the components and/or interconnect the spaced apart walls. Significantly, the blow-molded components may be lightweight, rigid, durable, weather resistant and generally temperature insensitive. In addition, the blow-molded plastic components may not corrode, rust or otherwise deteriorate over time. Further, the blow-molded components can also be formed in various shapes, sizes, configurations and designs.

Yet another aspect is an animal enclosure that may be sized and configured to be shipped and transported in relatively small sized packaging. Desirably, the components of the animal enclosure are sized and configured to fit within a limited area so that the size of the packaging is decreased.

Still another aspect is an animal enclosure that may be constructed from plastic, such as high density polyethylene. The polyethylene may contain additives, such as ultraviolet (UV) inhibitors, if desired.

Another aspect is an animal enclosure that may be quickly and easily assembled, which may reduce manufacturing and labor costs. In addition, this may allow consumers to quickly and easily assemble the animal enclosure. For example, the animal enclosure may include walls, floors and/or roof portions that are constructed from relatively lightweight blow-molded plastic and these portions may include connectors that are sized and configured to allow the parts to be easily interconnected. Significantly, because these features may be integrally formed in the various components, the manufacturing and assembly of the animal enclosure may be relatively fast and efficient. One skilled in the art will appreciate that various suitable type of fasteners, connectors, and the like may be used to assemble the structure.

Yet another aspect is an animal enclosure that may contain one or more living hinges. For example, the corners of the animal enclosure may formed by blow-molded panels that are folded at a living hinge. In addition, the roof and/or side walls may include one or more living hinges. Advantageously, the living hinges may allow the animal enclosure to be quickly and easily moved between the use and collapsed positions. In addition, the living hinges may allow various components of the animal enclosure to be molded in a generally flat or planar configuration. Further, the living hinges may allow these components to be shipped in a flat or planar configuration, which may significantly decrease the size of the packaging. Significantly, the living hinges may be generally resistant or impervious to the elements, such as wind or rain, which may allow the animal enclosure to be used in a wide range of environments and locations. In addition, the living hinges may increase the strength and/or rigidity of the structure, and allow the structure to be more easily assembled.

Still another aspect is an animal enclosure that may include one or more skylights. The skylights are preferably located in the roof but the skylights can be located in any desired portions of the animal enclosure. The skylights may be constructed from any suitable type of material, such as injection molded plastic, and the skylights may include a living hinge. The skylights may be permanently fastened to the animal enclosure or at least a portion of the skylights may be selectively attached to the animal enclosure to form a vent or opening.

Another aspect is an animal enclosure that may include a plurality of floor panels, wall panels and/or roof panels that are interconnected to form the animal enclosure. Preferably, the floor panels, wall panels and/or roof panels are connected to adjacent floor panels, wall panels or roof panels, respectively, to create a relatively strong and secure animal enclosure. The floor panels, wall panels and/or roof panels may include, for example, one or more overlapping or interlocking portions and these overlapping or interlocking portions may facilitate attachment of the various components. In addition, the overlapping or interlocking portions may include one or more extensions, flanges, projections, lips, etc., and one or more corresponding receiving portions, notches, grooves, openings, etc., to allow the portions to be interconnected. The floor panels, sidewall and/or roof panels may also be connected by any suitable type of connectors or fasteners, such as screws, bolts, adhesives, and the like.

A further aspect is an animal enclosure that may be sized and configured to be quickly and easily moved between the expanded and collapsed positions. Desirably, the walls and the roof are foldable to allow the animal enclosure to be moved between the use and collapsed positions. For example, the roof may include four roof panels, which may be folded. The walls may also include one or more wall panels, which may be folded. Significantly, this may allow the animal enclosure to take up a relatively small amount of space in the folded position. Of course, the walls, the roof and/or the floor may be foldable into any desired configuration or arrangement.

Still another aspect is an animal enclosure that may have various suitable sizes and configurations. For example, the animal enclosure may have one size for relatively large size animals and another size for smaller size animals. It will be appreciated that the animal enclosure may have any suitable size depending, for example, upon the intended use of the animal enclosure.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a front perspective view of an exemplary expandable structure, illustrating an animal enclosure in an expanded or use position;

FIG. 2 is a rear perspective view of the animal enclosure shown in FIG. 1;

FIG. 3 is a front perspective view of the animal enclosure shown in FIG. 1, illustrating a front wall in a collapsed position;

FIG. 4 is another front perspective view of the animal enclosure shown in figure 1, illustrating the roof in a partially collapsed position;

FIG. 5 is still another front perspective view of the animal enclosure shown in figure 1, illustrating the walls and the roof in a partially collapsed position;

FIG. 6 is yet another front perspective view of the animal enclosure shown in figure 1, illustrating the walls and the roof in another partially collapsed position;

FIG. 7 is a further front perspective view of the animal enclosure shown in figure 1, illustrating the animal enclosure in the collapsed position;

FIG. 8 is a side view of another exemplary animal enclosure, illustrating the animal inclosure in an expanded or use position;

FIG. 9 is another side view of the animal enclosure shown in FIG. 8, illustrating the walls and the roof in a partially collapsed position;

FIG. 10 is still another side view of the animal enclosure shown in FIG. 8, illustrating the walls and the roof in the collapsed position;

FIG. 11 is a side view of still another exemplary animal enclosure, illustrating the animal enclosure in an expanded or use position;

FIG. 12 is another side view of the animal enclosure shown in FIG. 11, illustrating the walls and the roof in a partially collapsed position; and

FIG. 13 is still another side view of the animal enclosure shown in FIG. 11, illustrating the walls and the roof in the collapsed position.

### DETAILED DESCRIPTION OF THE PREFERRED EMBODIMENTS

Before describing preferred and other exemplary embodiments in greater detail, several introductory comments regarding the general applicability and scope of the invention may be helpful.

First, the invention is generally directed towards an expandable structure. Advantageously, the expandable structure could be used to form a number of different types of structures or enclosures, such as a pet house. It will be appreciated that the pet house may be used to house, confine and/or transport a variety of animals depending, for example, upon its intended use. The principles of the present invention, however, are not limited to a pet house. It will be understood that, in light of the present disclosure, the expandable structure could be used for a variety of other purposes, functions and uses.

Second, it will be appreciated that the pet house may have a variety of suitable shapes, arrangements, configurations and the like. Further, the sizes and dimensions of the pet house can be varied depending, for example, upon its intended use and/or desired purpose.

Third, the particular materials and processes used to construct the pet house are for illustrative purposes. For example, as discussed in greater detail below, blow-molded plastic is preferably used to construct various portions of the pet house. It will be understood, however, that other materials can also be used, such as thermoplastics, resins, polymers, acrylonitrile butadiene styrene (ABS), polyurethane, nylon, composites and the like. It will also be understood that other suitable processes may be used to construct these various components, such as extrusion molding, injection molding, vacuum molding, rotational molding and the like. Further, it will be understood that these and other components of the pet house can be constructed from other materials such as metal (including steel, aluminum, etc.), wood and the like.

Further, to assist in the description of the pet house, words such as upper, lower, top, bottom, front, back, right and left are used to describe the accompanying figures. It will be appreciated, however, that the pet house can be located in a variety of desired positions, angles and orientations. A detailed description of the enclosure now follows.

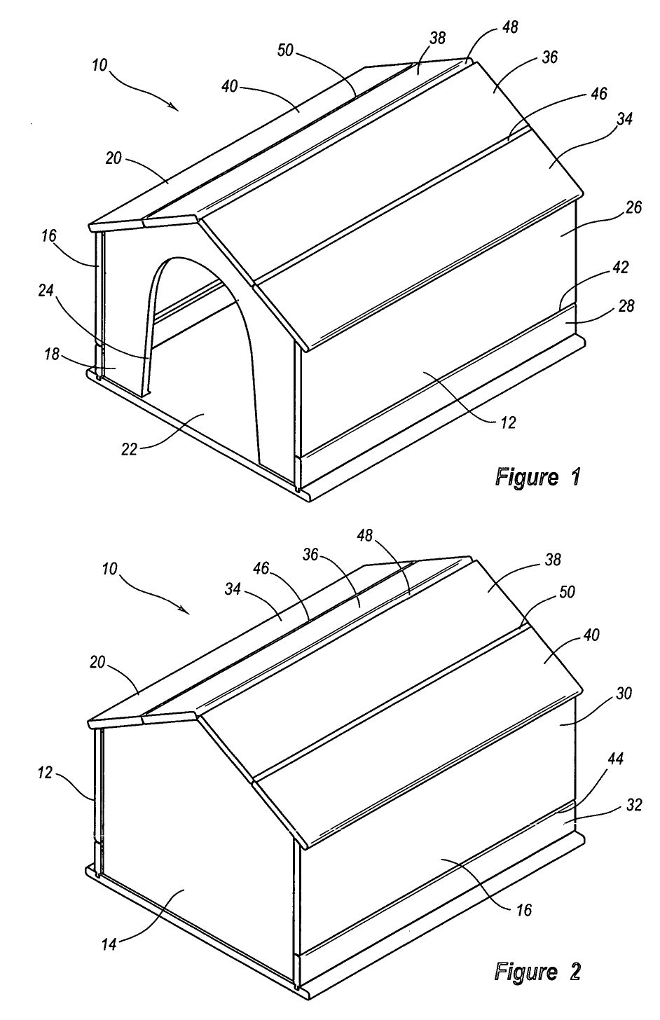

As shown in FIG. 1, an exemplary embodiment of an enclosure 10 is illustrated as a pet house and it may include one or more walls, such as a right wall 12, a rear wall 14, a left wall 16 and a front wall 18. The enclosure 10 may also include a roof 20 and a floor 22. The front wall 18 may include an opening 24, which may be sized and configured to permit an animal to enter and/or exit the enclosure 10. It will be appreciated that the opening 24 may be larger or smaller to accommodate a variety of different animals. Further, a door, gate or other structure may be provided to selectively cover all or at least a portion of the opening 24 to help confine an animal within the enclosure 10 and/or to shelter the interior of the enclosure.

As shown in FIGS. 1 and 2, the enclosure 10 is constructed from a number of components that are interconnected to form the enclosure. In particular, as described in greater detail below, the walls 12, 14, 16, 18 of the enclosure 10 can be constructed from a number of interconnected panels. Additionally, the roof 20 may include a number of interconnected panels and the floor 22 may also include a number of interconnected panels. It will be appreciated that the number of components used to form the walls 12, roof 20 and floor 22 may depend, for example, upon the size and configuration of the enclosure 10.

Significantly, the various components may allow the enclosure 10 to be relatively quickly and easily assembled. This may allow, for example, the manufacturing costs of the enclosure 10 to be decreased. This may also allow the enclosure 10 to be shipped in an unassembled and/or collapsed configuration and the consumer may be able to quickly and easily assemble the enclosure. Advantageously, shipping the enclosure 10 in an unassembled and/or collapsed configuration may reduce shipping costs and increase the potential uses of the enclosure. As discussed in greater detail below, the components of the enclosure 10 are preferably generally lightweight and that may also reduce shipping costs and facilitate transportation or shipping of the enclosure. Additionally, while the enclosure 10 may be shown in the accompanying drawings as having a general size and configuration, it will be appreciated that the enclosure may be larger, smaller or have other suitable dimensions.

Various exemplary features and aspects of the enclosure 10 will now be discussed in more detail. It will be appreciated that the enclosure 10 does not require all or any of these exemplary features and aspects, and the enclosure could have other suitable features and aspects depending, for example, upon the intended design, use or purpose of the enclosure.

As shown in FIGS. 1 and 2, the walls may include a single wall panel or a plurality of wall panels. For example, the right wall 12 may be constructed from wall panels 26, 28; and the left wall 16 may be constructed from wall panels 30, 32. Also, the front and rear walls 14, 18 may respectively be constructed from a single wall panel. These wall panels may be used to construct an enclosure 10 with a generally rectangular configuration. It will be appreciated, however, that the enclosure 10 could have other suitable configurations such as square, polygonal, triangular, circular and the like.

The roof 20 may be constructed from one or more roof panels, such as roof panels 34, 36, 38, 40. The floor 22 is preferably constructed from a single panel, but it may also be constructed from one or more panels. Thus, the walls 12, 14, 16 and 18; the roof 20; and/or the floor 22 may be constructed using one or more panels, depending, for example, upon the particular configuration of the enclosure 10.

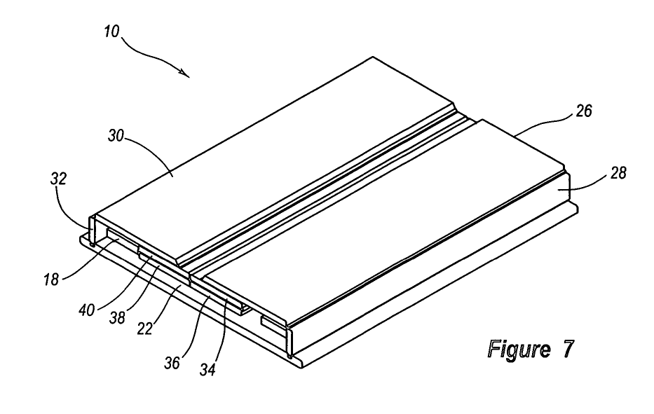

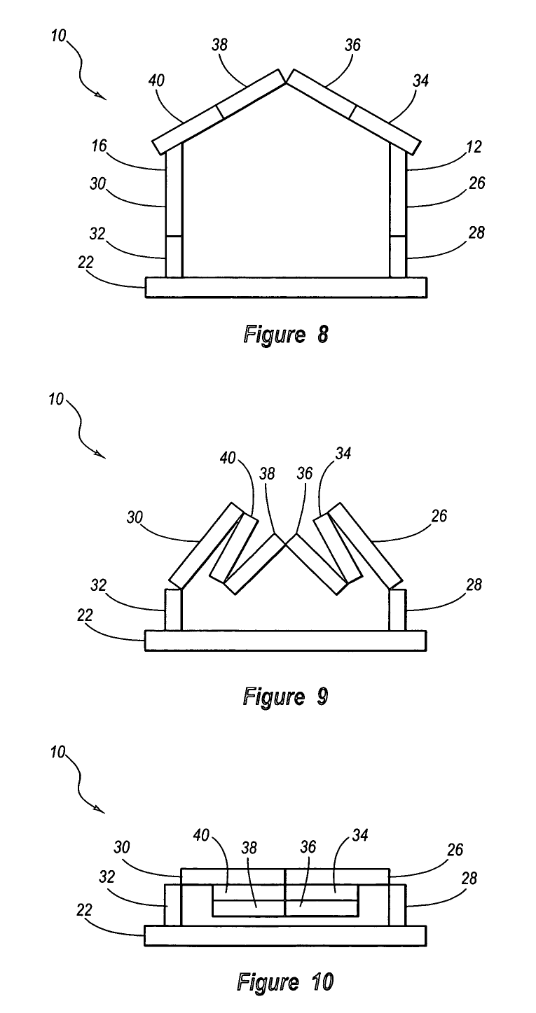

As shown in FIGS. 1 and 2, the walls 12, 16 desirably include a first portion and a second portion separated by a living hinge. In greater detail, the wall 12 preferably includes a living hinge 42 that movably interconnects the wall panels 26, 28; and the wall 16 preferably includes a living hinge 44 that movably interconnects the wall panels 30, 32. Preferably, the living hinges extend from a first side to a second side of the wall and the living hinges allow the first and second portions to pivot or otherwise move relative to each other. For example, the living hinges may allow the walls 12, 16 to be positioned in a generally flat, planar configuration, which may facilitate expansion or use of the enclosure 10 as shown in FIGS. 1 and 8. The living hinges may also allow the walls 12, 16 to be disposed in a collapsed position as shown in FIGS. 7 and 10. Advantageously, if the living hinges extend the entire width of the walls 12, 16, then that may help prevent water and foreign objects from undesirably entering the enclosure 10. In addition, the living hinges may allow a strong and sturdy connection of the first and second portions of the walls 12, 16 to be created. It will be appreciated that the walls 12, 16 may also include one or more living hinges, which may extend along all or just a portion of the length of the walls, and the wall panels could be disposed at other suitable angles. It will also be appreciated that the walls 12, 16 do not require living hinges and the wall panels may have other suitable configurations, arrangements, connections and the like.

As shown in FIGS. 1 and 2, the roof 20 may also include a plurality of roof panels connected by living hinges. For example, the roof 20 preferably includes living hinges 46, 48, 50 that movably interconnect the roof panels 34, 36, 38, 40. Preferably, the living hinges 46, 48, 50 extend from a first side to a second side of the roof and allows the roof panels 34, 36, 38, 40 to pivot or otherwise move relative to each other. For example, to facilitate use or expansion of the enclosure 10 as shown in FIGS. 1 and 8, the living hinges 46, 48, 50 may allow the adjacent roof panels 34, 36 to be positioned in a generally flat, planar configuration; allow the adjacent roof panels 36, 38 to be disposed at an angle; and allow the adjacent roof panels 38 and 40 to be positioned in a generally flat, planar configuration. In addition, to allow the enclosure to be disposed in a collapsed position as shown in FIGS. 7 and 10, the living hinges 46, 48, 50 may allow the adjacent roof panels 34, 36 to be disposed at an angle; allow the adjacent roof panels 36, 38 to be positioned in a generally flat, planar configuration; and allow the adjacent roof panels 38 and 40 to be disposed at an angle.

Advantageously, if the living hinges 46, 48, 50 extend the entire width of the roof 20, that may help prevent water and foreign objects from undesirably entering the enclosure 10. In addition, the living hinges 46, 48, 50 may allow a strong and sturdy connection of the roof panels 34, 36, 38, 40 to be created. It will be appreciated that the roof 20 may include one or more living hinges, which may extend along all or just a portion of the length of the roof, and the roof panels could be disposed at other suitable angles. It will also be appreciated that the roof 20 does not require living hinges and the roof panels may have other suitable configurations, arrangements, connections and the like.

As shown in the accompanying figures, the walls 12, 14, 16, 18 may be connected to the roof 20 and/or the floor 22. For example, the lower wall panel 28 of the right wall 12 may be fixedly connected to the floor 22; and the upper wall panel 26 of the right wall 12 may be pivotally or otherwise movably connected to the roof panel 34 of the roof 20. Also, the lower wall panel 32 of the left wall 16 may be fixedly connected to the floor 22; and the upper wall panel 30 of the left wall 16 may be pivotally or otherwise movably connected to the roof panel 40 of the roof 20. In addition, the front wall 18 may be pivotally or otherwise movably connected to the floor 22, and the rear wall 14 may be pivotally or otherwise movably connected to the floor. It will be appreciated that the walls 12, 14, 16, 18 may be connected to the roof 20 and/or the floor 22 with other suitable arrangements and configurations.

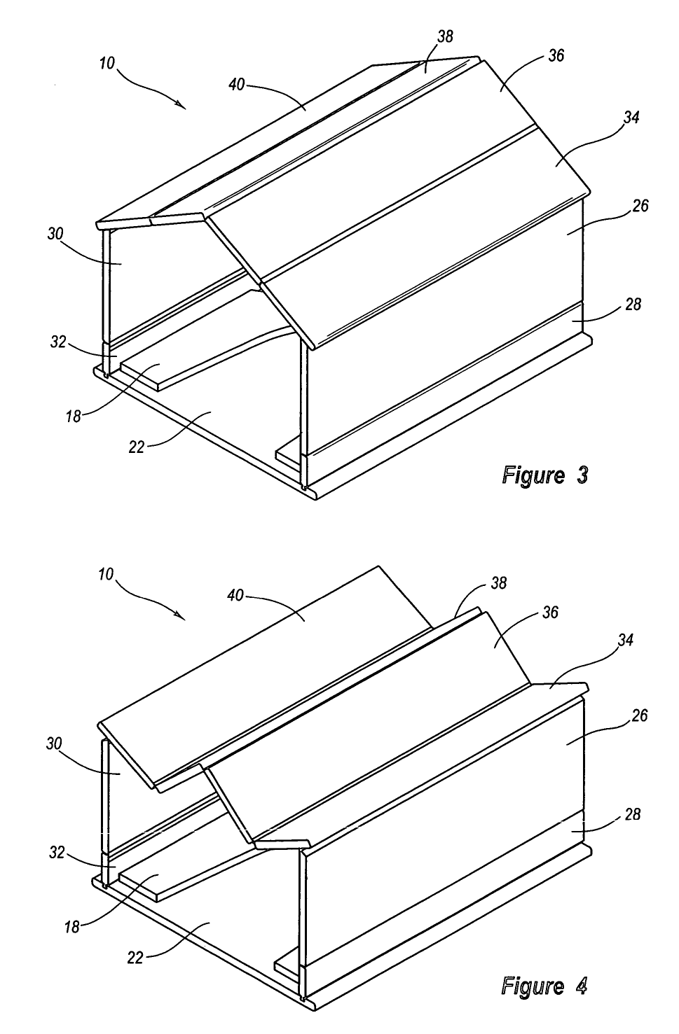

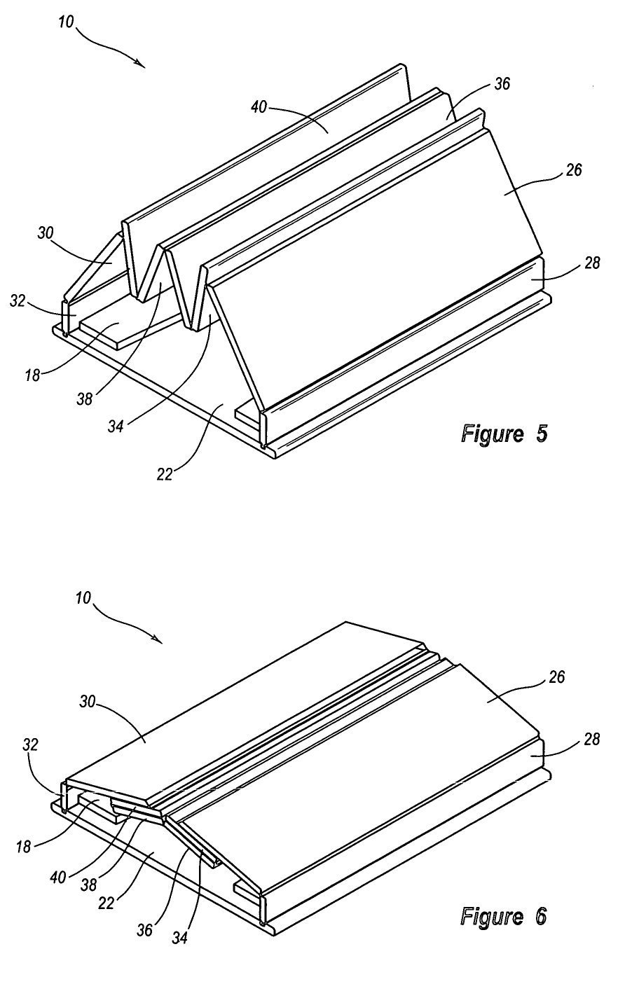

Advantageously, with the walls 12, 14, 16, 18 connected to the roof 20 and/or the floor 22, the enclosure 10 may be conveniently moved between an expanded configuration and a collapsed configuration, as shown in FIGS. 3-7 and in FIGS. 8-10. In particular, to collapse the enclosure 10, the wall 18 may collapse such that at least a portion of the interior surface of the wall 18 moves toward the upper surface of floor 22; and, likewise, wall 14 may collapse such that at least a portion of the interior surface of the wall 14 moves toward the upper surface of floor. Also, to collapse the enclosure 10, the roof panels 34, 36, 38, 40 may collapse; and the right wall 12 and the left wall 16 may also collapse. In particular, the upper wall panel 26 of the right wall 12 and the roof panel 34 may be disposed adjacent to each other, and the upper wall panel 30 of the left wall 16 and the roof panel 40 may be disposed adjacent to each other when the enclosure 10 is in the collapsed position.

With the enclosure 10 in the collapsed configurations as shown in FIGS. 7 and 10, at least a portion of the exterior surfaces or portions of the roof panels 34, 36 may contact, abut and/or engage each other; at least a portion of the exterior surfaces or portions of the roof panels 38, 40 may contact, abut and/or engage each other; at least a portion of the interior surfaces or portions of the wall panel 26 and the roof panel 34 may contact, abut and/or engage each other; and at least a portion of the interior surfaces or portions of the wall panel 30 and the roof panel 40 may contact, abut and/or engage each other. Additionally, in the collapsed configuration, at least a portion of the interior surface of the front wall 18 and at least a portion of the upper surface of the floor 22 may contact, abut and/or engage each other; and at least a portion of the interior surface of the wall rear 14 and at least a portion of the exterior surface of the front wall 18 may contact, abut and/or engage each other. Further, in the collapsed configuration, at least a portion of the interior surface of the rear wall 14 and at least a portion of the upper surface of the floor 22 may contact, abut and/or engage each other; and at least a portion of the interior surface of the front wall 18 and at least a portion of the exterior surface of the rear wall 14 may contact, abut and/or engage each other. It will be appreciated that the enclosure 10 may have a variety of other suitable arrangements and configurations in the collapsed position.

With the enclosure 10 in a collapsed configuration as shown in FIG. 7, the top portions of the wall panels 26, 30 may be generally spaced apart, for example, to provide a larger roof overhang. However, with the enclosure 10 in a collapsed configuration as shown in FIG. 10, the top portions of the wall panels 26, 30 may be positioned closer together. Further, it will be appreciated that the enclosure 10 could include a roof overhang of any suitable size and configuration, but the enclosure does not require a roof overhang.

In order to move the enclosure 10 from the collapsed position to the expanded position, the above-described steps may be reversed. It will also be appreciated that the enclosure 10 may be collapsed and/or expanded using a variety of other methods, configurations and the like.

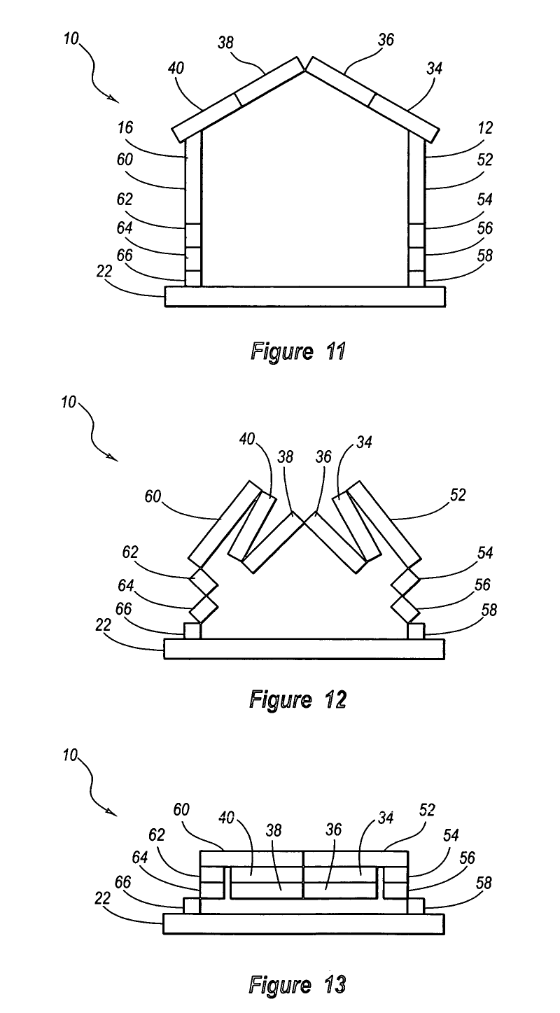

For example, as shown in FIGS. 11-13, the enclosure 10 may have other suitable configurations and arrangements. In particular, the wall 12 may include wall panels 52, 54, 56 and 58, which may be interconnected using one or more living hinges and/or other suitable structures. In greater detail, the wall panel 52 may be pivotally or otherwise movably connected to the roof panel 34 and pivotally or otherwise movably connected to the wall panel 54. The wall panel 54 may be pivotally or otherwise movably connected to the wall panels 52, 56. The wall panel 56 may be pivotally or otherwise movably connected to the wall panels 54, 58. The wall panel 58 may be pivotally or otherwise movably connected to the wall panel 56 and connected to the floor 22. Similarly, the wall 16 may include wall panels 60, 62, 64, 66, which may be interconnected using one or more living hinges and/or other suitable structures. The wall panel 60 may be pivotally or otherwise movably connected to the roof panel 40 and pivotally or otherwise movably connected to the wall panel 62. The wall panel 62 may be pivotally or otherwise movably connected to the wall panels 60, 64. The wall panel 64 may be pivotally or otherwise movably connected to the wall panels 62, 66. The wall panel 66 may be pivotally or otherwise movably connected to the wall panel 64 and connected to the floor 22.

The enclosure 10 shown in FIGS. 11-13 may be conveniently moved between an expanded configuration and a collapsed configuration in a similar manner as discussed above. For example, in order to collapse the enclosure 10, the roof panels 34, 36 may collapse with at least a portion of their exterior surfaces moving toward each other, and the roof panels 38, 40 collapse with at least a portion of their exterior surfaces moving toward each other. Also, the wall panel 52 and the roof panel 34 may collapse with at least a portion of their interior surfaces moving toward each other; and the wall panel 60 and the roof panel 40 may collapse with at least a portion of their interior surfaces moving toward each other. As shown in the accompanying figures, the wall panels 52, 54 may collapse with at least a portion of their interior surfaces moving toward each other; the wall panels 54, 56 may collapse with at least a portion of their exterior surfaces moving toward each other; the wall panels 56, 58 may collapse with at least a portion of their interior surfaces moving toward each other; the wall panels 60, 62 may collapse with at least a portion of their interior surfaces moving toward each other; the wall panels 62, 64 may collapse with at least a portion of their exterior surfaces moving toward each other; and the wall panels 64, 66 may collapse with at least a portion of their interior surfaces moving toward each other.

With the enclosure 10 in a collapsed configuration as shown in FIG. 13, at least a portion of the exterior surfaces or portions of the roof panels 34, 36 may contact, abut and/or engage each other; and at least a portion of the exterior surfaces or portions of the roof panels 38, 40 may contact, abut and/or engage each other. Also, at least a portion of the interior surfaces or portions of the wall panel 52 and the roof panel 34 may contact, and/or engage each other; and at least a portion of the interior surfaces or portions of the wall panel 60 and the roof panel 40 may contact, abut and/or engage each other. Additionally, at least a portion of the interior surfaces or portions of the wall panels 52, 54 may contact, abut and/or engage each other; and at least a portion of the interior surfaces or portions of the wall panels 60, 62 may contact, abut and/or engage each other; at least a portion of the exterior surfaces or portions of the wall panels 54, 56 may contact, abut and/or engage each other; and at least a portion of the exterior surfaces or portions of the wall panels 62, 64 may contact, abut and/or engage each other. It will be appreciated that the enclosure 10 could also have other suitable components and arrangements, the enclosure could have other expanded and collapsed configurations, and the enclosure could be expanded and collapsed in order manners or sequences.

Advantageously, the enclosure 10 may be collapsed into a small, compact size, which may facilitate shipping and transportation of the enclosure. For example, as shown in FIGS. 7, 10 and 13, the floor 22 and the walls 12, 16 may form at least a portion of envelope in which at least a portion of the wall 14, at least a portion of the wall 18 and/or at least a portion of the roof 22 may be disposed when the enclosure 10 is in the collapsed position. Advantageously, this collapsed configuration may help reduce shipping costs and increase the potential uses of the enclosure.

The walls 12, 14, 16, 18; the roof 20; and the floor 22 are preferably constructed from a lightweight material such as plastic. In particular, these and other components may be constructed from high density polyethylene and these components are desirably formed by a blow-molding process. The blow-molding process may allow strong, lightweight, rigid and sturdy components to be quickly and easily manufactured. In particular, the blow-molded components may include a hollow interior portion that is formed during the blow-molding process, which may allow a lightweight component to be manufactured. Advantageously, this may allow the enclosure 10 to have significantly lighter weight than conventional enclosures constructed from wood or metal. In addition, constructing the enclosure 10 from blow-molded plastic may allow the enclosure to be constructed from less plastic, which may save manufacturing costs and reduce consumer costs. The blow-molded plastic may also include ultraviolet (UV) inhibitors that help prevent the plastic from deteriorating when exposed to sunlight. It will be appreciated that other suitable plastic, materials and/or processes may also be used to construct these and other components depending, for example, upon the particular design and use of the enclosure 10.

The enclosure 10 may also be constructed from blow-molded plastic because this may allow the enclosure to be economically manufactured. In addition, the blow-molded plastic may allow the enclosure 10 to be readily produced because, among other reasons, the components may be quickly manufactured and the blow-molded plastic components may be created with a variety of suitable shapes, sizes, designs and/or colors depending, for example, upon the intended use of the enclosure. Further, the blow-molded plastic components may be durable, weather resistant, generally temperature insensitive, corrosion resistant, rust resistant and generally do not deteriorate over time. Thus, the blow-molded plastic may allow a long-lasting and durable enclosure 10 to be constructed.

The blow-molded plastic components of the enclosure 10 may also include one or more depressions, indentations or the like, and these depressions may be sized and configured to increase the strength and/or rigidity of the component. These depressions, which may also be known as “tack-offs,” preferably cover at least a substantial portion of the components and the depressions may be arranged into a predetermined pattern. The depressions, for example, may be formed in one surface and extend towards an opposing surface. The ends of the depressions may contact or engage the opposing surface and/or the ends of the depressions may be spaced apart from the opposing surface. Advantageously, the depressions may help support the opposing surface and/or increase the structural integrity of the component. In addition, the depressions may be closely spaced in order to increase the strength and/or structural integrity of the component. Further, the depressions may be spaced or positioned into a generally regular or constant pattern so that the component has generally consistent properties. It will be appreciated that the depressions may have a variety of suitable configurations and arrangements. For instance, additional information regarding other suitable configurations and arrangements of the depressions is disclosed in Assignee's co-pending U.S. patent application Ser. No. 10/490,000, entitled HIGH STRENGTH, LIGHT WEIGHT BLOW-MOLDED PLASTIC STRUCTURES, which was filed on Apr. 8, 2003; and U.S. Provisional Patent Application Ser. No. 60/659,982, entitled HIGH-STRENGTH, LIGHTWEIGHT BLOW-MOLDED PLASTIC STRUCTURES, which was filed on Mar. 9, 2005. These applications are incorporated by reference in their entireties.

The depressions may also be positioned on opposing surfaces of various components of the enclosure 10, if desired. For example, one or more depressions may be formed on a first surface and these depressions may extend towards and/or contact the second, opposing surface. In addition, one or more depressions may be formed on the second surface and these depressions may extend towards and/or contact the first surface. These depressions on the first and second surfaces may be generally aligned and the ends of the opposing depressions may touch or engage. Significantly, this may create depressions that may contact and support the opposing surface, but the depressions have a smaller size and/or height than conventional depressions because the depressions do not span the entire distance between the opposing surfaces. In contrast, the depressions on the opposing surfaces only span a portion of the distance separating the opposing surfaces.

Because the depressions may be integrally formed during the manufacturing process, this may allow the enclosure to be quickly and easily manufactured. In addition, because features such as the living hinge may be integrally formed during the manufacturing process, blow-molded plastic is preferably used to construct various components of the enclosure 10. Further, if the living hinge is integrally formed during the manufacturing process, it may reduce the steps and time required to assemble the enclosure.

One skilled in the art, however, will appreciate that the components do not have to be constructed from blow-molded plastic and other suitable materials and/or processes can be used to construct the various components depending, for example, upon the intended use of the enclosure 10. Thus, some or all of the components could also be constructed from other materials with suitable characteristics, such as wood, metal and other types of plastic. Additionally, all the components do not have to be constructed from blow-molded plastic and some or all of the components could be constructed from injection molded plastic, extrusion molded plastic, and the like.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. An animal enclosure that is capable of being moved between a first position in which the animal enclosure is sized and configured to be used and a second position in which the animal enclosure is collapsed to facilitate transportation and/or storage, the animal enclosure comprising:
a first wall;
a second wall;
a roof connected to the first wall and the second wall; and
a floor connected to the first wall and the second wall, at least a portion of the floor, the first wall and the second wall forming an envelope that is sized and configured to receive at least a portion of the roof when the animal enclosure is in the second position.

2. The animal enclosure as in claim 1, wherein the roof includes a first roof panel, a second roof panel, a third roof panel and fourth roof panel; the first roof panel and the second roof panel are disposed on one side of the animal enclosure and the third roof panel and the fourth roof panel are disposed on another side of the animal enclosure when the animal enclosure is in the first position; the first roof panel, the second roof panel, the third roof panel and the fourth roof panel being at least substantially disposed within the envelope when the animal enclosure is in the second position.

3. The animal enclosure as in claim 1, wherein the roof includes a first roof panel, a second roof panel, a third roof panel and fourth roof panel; an exterior portion of the first roof panel being sized and configured to abut an exterior portion of the second roof panel when the animal enclosure is in the second configuration; and an exterior portion of the third roof panel being sized and configured to abut an exterior portion of the fourth roof panel when the animal enclosure is in the collapsed configuration.

4. The animal enclosure as in claim 1, wherein the roof includes a first roof panel, a second roof panel, a third roof panel and fourth roof panel; the first roof panel being sized and configured to abut an interior portion of the first wall when the animal enclosure is in the second position; and the fourth roof panel being sized and configured to abut an interior portion of the second wall when the animal enclosure is in the second position.

5. The animal enclosure as in claim 1, wherein the roof further comprises:
a first roof panel;
a second roof panel;
a first living hinge at least partially interconnecting the first roof panel and the second roof panel;
a third roof panel;
a second living hinge at least partially interconnecting the second roof panel and roof panel;
a fourth roof panel; and
a third living hinge at least partially interconnecting the third roof panel and the fourth roof panel.

6. The animal enclosure as in claim 1, wherein the first wall includes a first portion, a second portion and a living hinge connecting the first portion and the second portion; the first portion being connected to the roof and the second portion being connected to the floor; and
wherein the second wall includes a first portion, a second portion and a living hinge connecting the first portion and the second portion; the first portion being connected to the roof and the second portion being connected to the floor.

7. The animal enclosure as in claim 1, wherein the first wall includes a first portion, a second portion, a third portion and a fourth portion, the first portion being connected to the roof and the fourth portion being connected to the floor; and
wherein the second wall includes a first portion, a second portion, a third portion and a fourth portion, the first portion being connected to the roof and the fourth portion being connected to the floor.

8. An animal enclosure that is capable of being moved between a first position in which the animal enclosure is sized and configured to be used and a second position in which the animal enclosure is collapsed to facilitate transportation and/or storage, the animal enclosure comprising:
a first wall;
a second wall;
a floor connected to the first wall and the second wall; and
a roof connected to the first wall and the second wall, the roof including a first portion; a second portion; a third portion and a fourth portion; an exterior portion of the first portion being sized and configured to abut an exterior portion of the second portion when the animal enclosure is in the second position; and an
exterior portion of the third portion being sized and configured to abut an exterior portion of the fourth portion when the animal enclosure is in the second position.

9. The animal enclosure as in claim 8, wherein the first wall, the second wall and the floor are sized and configured to form at least a portion of an envelope when the animal enclosure is in the second position.

10. The animal enclosure as in claim 9, wherein the first wall, the second wall and the floor are sized and configured to receive at least a portion of the roof when the animal enclosure is in the second position.

11. The animal enclosure as in claim 8, wherein a first living hinge connects the first portion of the roof and the second portion of the roof;
wherein a second living hinge connects the second portion of the roof and the third portion of the roof; and
wherein a third living hinge connects the third portion of the roof and the fourth portion of the roof.

12. The animal enclosure as in claim 8, wherein the first portion of the roof is sized and configured to abut an interior portion of the first wall when the animal enclosure is in the second position; and
wherein the fourth portion of the roof is sized and configured to abut an interior portion of the second wall when the animal enclosure is in the second position.

13. The animal enclosure as in claim 8, wherein the first wall includes a first portion, a second portion and a living hinge connecting the first portion and the second portion; the first portion being connected to the roof and the second portion being connected to the floor; and
wherein the second wall includes a first portion, a second portion and a living hinge connecting the first portion and the second portion; the first portion being connected to the roof and the second portion being connected to the floor.

14. The animal enclosure as in claim 8, wherein the first wall includes a first portion, a second portion, a third portion and a fourth portion, the first portion being connected to the roof and the fourth portion being connected to the floor; and
wherein the second wall includes a first portion, a second portion, a third portion and a fourth portion, the first portion being connected to the roof and the fourth portion being connected to the floor.

15. An animal enclosure that is capable of being moved between a first position in which the animal enclosure is sized and configured to be used and a second position in which the animal enclosure is collapsed to facilitate transportation and/or storage, the animal enclosure comprising:
a roof;
a floor;
a first wall including a first portion, a second portion and a living hinge connecting the first portion and the second portion, the first portion being connected to the roof and the second portion being connected to the floor, an interior portion of the first portion of the first wall being sized and configured to move toward an interior portion of the roof and toward an upper portion of the floor as the animal enclosure is moved from the first position to the second position; and
a second wall including a first portion, a second portion and a living hinge connecting the first portion and the second portion, the first portion being connected to the roof and the second portion being connected to the floor, an interior portion of the first portion of the second wall being sized and configured to move toward an interior portion of the roof and toward an upper portion of the floor as the animal enclosure is moved from the first position to the second position.

16. The animal enclosure as in claim 15, wherein the first wall, the second wall and the floor form at least a portion of an envelope in the second position that is sized and configured to receive at least a portion of the roof in the second position.

17. The animal enclosure as in claim 16, wherein the roof includes a first roof panel, a second roof panel, a third roof panel and fourth roof panel; the first roof panel, the second roof panel, the third roof panel and the fourth roof panel being at least substantially disposed within the envelope when the animal enclosure is in the second position.

18. The animal enclosure as in claim 15, wherein the roof includes a first roof panel, a second roof panel, a third roof panel and fourth roof panel; an exterior portion of the first roof panel being sized and configured to abut an exterior portion of the second roof panel when the animal enclosure is in the second configuration; and an exterior portion of the third roof panel being sized and configured to abut an exterior portion of the fourth roof panel when the animal enclosure is in the collapsed configuration.

19. The animal enclosure as in claim 15, wherein the roof includes a first roof panel, a second roof panel, a third roof panel and fourth roof panel; the first roof panel sized and configured to abut an interior portion of the first wall when the animal enclosure is in the second position; and the fourth roof panel being sized and configured to abut an interior portion of the second wall when the animal enclosure is in the second position.

20. The animal enclosure as in claim 15, wherein the roof further comprises:
a first roof panel;
a second roof panel;
a first living hinge at least partially interconnecting the first roof panel and the second roof panel;
a third roof panel;
a second living hinge at least partially interconnecting the second roof panel and the third roof panel;
a fourth roof panel; and
a third living hinge at least partially interconnecting the third roof panel and the fourth roof panel.
